(19) United States
(12) Patent Application Publication
(10) Pub. No.: US 2022/0207362 A1
(43) Pub. Date: Jun. 30, 2022

(54) System and Method For Multi-Task Learning Through Spatial Variable Embeddings

(71) Applicant: Cognizant Technology Solutions U.S. Corporation, College Station, TX (US)

(72) Inventors: Elliot Meyerson, Pasadena, CA (US); Risto Miikkulainen, Stanford, CA (US)

(73) Assignee: Cognizant Technology Solutions U.S. Corporation, College Station, TX (US)

(21) Appl. No.: 17/554,097

(22) Filed: Dec. 17, 2021

Related U.S. Application Data
(60) Provisional application No. 63/132,591, filed on Dec. 31, 2020.

(51) Int. Cl. G06N 3/08; G06N 3/04; G06N 3/06; G06F 17/16

(52) U.S. Cl. CPC G06N 3/08; G06F 17/16; G06N 3/06; G06N 3/0454

(57) ABSTRACT

A general prediction model is based on an observer traveling around a continuous space, measuring values at some locations, and predicting them at others. The observer is completely agnostic about any particular task being solved; it cares only about measurement locations and their values. A machine learning framework in which seemingly unrelated tasks can be solved by a single model is proposed, whereby input and output variables are embedded into a shared space. The approach is shown to (1) recover intuitive locations of variables in space and time, (2) exploit regularities across related datasets with completely disjoint input and output spaces, and (3) exploit regularities across seemingly unrelated tasks, outperforming task-specific single-task models and multi-task learning alternatives.

### CROSS REFERENCE TO RELATED APPLICATIONS

The present application claims benefit of and priority to U.S. Provisional Patent Application No. 63/132,591 similarly entitled SYSTEM AND METHOD FOR MULTI-TASK LEARNING THROUGH SPATIAL VARIABLE EMBEDDINGS filed on Dec. 31, 2020, which is incorporated herein by reference in its entirety.

Cross-reference is made to commonly-owned U.S. patent application Ser. No. 16/817,153 entitled System and Method For Implementing Modular Universal Reparameterization For Deep Multi-Task Learning Across Diverse Domains and U.S. patent application Ser. No. 16/172,660 entitled BEYOND SHARED HIERARCHIES: DEEP MULTITASK LEARNING THROUGH SOFT LAYER ORDERING, which are incorporated herein by reference in their entirety.

The following document is also incorporated herein by reference in its entirety: Meyerson et al., THE TRAVELING OBSERVER MODEL: MULTI-TASK LEARNING THROUGH SPATIAL VARIABLE EMBEDDINGS, arXiv:2010.02354v4, Mar. 22, 2021.

Additionally, one skilled in the art appreciates the scope of the existing art which is assumed to be part of the present disclosure for purposes of supporting various concepts underlying the embodiments described herein. By way of particular example only, prior publications, including academic papers, patents and published patent applications listing one or more of the inventors herein are considered to be within the skill of the art and constitute supporting documentation for the embodiments discussed herein.

### COMPUTER PROGRAM LISTING

A Computer Program Listing is included in an Appendix to the present specification. The Appendix is provided at the end of the specification and before the claims and includes the following files:

2.87 kb “tom.py.txt”

766 b “core_res_ block.py.txt”

921 b “film.layer.py.txt”

778 b “film.res.block.py.txt”

911 b “inv_film_layer.py.txt”

### BACKGROUND

### Field of the Embodiments

The subject matter described herein, in general, relates to multi-task learning, and, in particular, relates to multi-task learning through spatial variable embeddings.

### Description of Related Art

Natural organisms benefit from the fact that their sensory inputs and action outputs are all organized in the same space, that is, the physical universe. This consistency makes it easy to apply the same predictive functions across diverse settings. Deep multi-task learning (Deep MTL) has shown a similar ability to adapt knowledge across tasks whose observed variables are embedded in a shared space. Examples include vision, where the input for all tasks (photograph, drawing, or otherwise) is pixels arranged in a 2D plane; natural language, speech processing and genomics, which exploit the 1D structure of text, waveforms, and nucleotide sequences; and video game-playing, where interactions are organized across space and time. Yet, many real-world prediction tasks have no such spatial organization; their input and output variables are simply labeled values, e.g., the height of a tree, the cost of a haircut, or the score on a standardized test. To make matters worse, these sets of variables are often disjoint across a set of tasks.

These challenges have led the MTL community to avoid such tasks, despite the fact that general knowledge about how to make good predictions can arise from solving seemingly “unrelated” tasks. Table 1 highlights Deep MTL methods from the perspective of decomposition into encoders and decoders. In MTL, there are T tasks {(xₜ, yₜ)}ₜ₌₁^{T} that can, in general, be drawn from different domains and have varying input and output dimensionality. The tth task has nₜ input variables [xₜ₁, . . . , xₜₙ_{ₜ}]=xₜ∈ [symbol] ⁿ^{ₜ} t and mₜ output variables [yₜ₁, . . . , yₜₘ_{ₜ}]=yₜ∈ [symbol] ^{m}^{ₜ}. Two tasks (xₜ, yₜ) and (x_{t′}, y_{t′}) are disjoint if their input and output variables are non-overlapping, i.e., ({xₜᵢ}ᵢ₌₁ⁿ^{ₜ}∩({yₜⱼ}ⱼ₌₁^{m}^{ₜ})∪({x_{t′i}}ᵢ₌₁ⁿ^{_{t′}}∩({y_{t′j}}ⱼ₌₁^{m}^{_{t′}})=ø. The goal is to exploit regularities across task models xₜ [symbol] ŷₜ by jointly training them with overlapping parameters.

TABLE 1

| (a) Intra-domain | (b) Task Embeddings | (c) Cross-domain |
|---|---|---|
| ŷₜ = gₜ (f(xₜ)) | ŷₜ = g(f(xₜ, zₜ))) | ŷₜ = gₜ(fₜ(xₜ)) |

The standard intra-domain approach is for all task models to share their encoder f, and each to have its own task-specific decoder gₜ as given in Table 1, (a). This setup was used in the original introduction of MTL and has been broadly explored in the linear regime, and is the most common approach in Deep MTL. The main limitation of the intra-domain approach is that it is limited to sets of tasks that are all drawn from the same domain. It also has the risk of the separate decoders doing so much of the learning that there is not much left to be shared, which is why the decoders are usually single affine layers.

To address the issue of limited sharing, the task embeddings approach as given in Table 1, (b) trains a single encoder f and single decoder g, with all task-specific parameters learned in embedding vectors zₜ that semantically characterize each task, and which are fed into the model as additional input. Such methods require that all tasks have the same input and output space, but are flexible in how the embeddings can be used to adapt the model to each task. As a result, they can learn tighter connections between tasks than separate decoders, and these relationships can be analyzed by looking at the learned embeddings.

Next, to exploit regularities across tasks from diverse and disjoint domains, cross-domain methods have been introduced. Existing methods address the challenge of disjoint output and input spaces by using separate decoders and encoders for each domain (Table 1, c), and thus they require some other method of sharing model parameters across tasks, such as sharing some of their layers or drawing their parameters from a shared pool. For many datasets, the separate encoder and decoder absorbs too much functionality to share optimally, and their complexity makes it difficult to analyze the relationships between tasks. Earlier work prior to deep learning showed that, from an algorithmic learning theory perspective, sharing knowledge across tasks should always be useful, but the accompanying experiments were limited to learning biases in a decision tree generation process, i.e., the learned models themselves were not shared across tasks.

None of these methods could optimally propose multi task encoder decoder decompositions in cross domain settings. In the background of foregoing limitations, there exists a need for a solution that can extend the notion of task embeddings in order to apply the idea in the cross-domain setting.

### SUMMARY OF THE EMBODIMENTS

In a first exemplary embodiment, a process, implemented in a computing environment, for training a single model across diverse tasks, includes: measuring tasks with disjoint input and output variable sets in a shared space; for each task, encoding by a function f a value of each observed variable xᵢ given its shared space location zᵢ; aggregating encodings by elementwise addition; and decoding by a function g the aggregated encodings to predict yⱼ at its location zⱼ, wherein zᵢ and zⱼ are variable embeddings.

In a second exemplary embodiment, at least one computer readable medium storing instructions that, when executed by a computer, perform a process for training a single model across diverse tasks, including: measuring tasks with disjoint input and output variable sets in a shared space; for each task, encoding by a function f a value of each observed variable xᵢ given its shared space location zᵢ; aggregating encodings by elementwise addition; and decoding by a function g the aggregated encodings to predict yⱼ at its location zⱼ, wherein zᵢ and zⱼ are variable embeddings.

In a third exemplary embodiment, a single universal prediction model trained across diverse tasks in a shared space with disjoint input and output variable sets, includes: an encoder, f, which is conditioned on vector zᵢ, for generating an encoder output for each task variable xᵢ given its location in the shared space; an aggregator for aggregating the encoder outputs; a core, g₁, which is independent of output variable; and a decoder, g₂, which is conditioned on vector zⱼ, for generating a prediction yⱼ given its location in the shared space.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1 depicts an exemplary traveling observer model (TOM) in accordance with an embodiment herein.

FIG. 2 diagrams a TOM implementation framework, in accordance with an embodiment herein.

FIGS. 3a, 3b, 3c, 3d, 3e, 3f, 3g and 3h demonstrate variable embeddings learned for CIFAR using TOM, in accordance with an embodiment herein.

FIGS. 4a, 4b, 4c, 4d, 4e, 4f, 4g and 4h demonstrate variable embeddings learned for daily temperature variables using TOM, in accordance with an embodiment herein.

FIGS. 5a, 5b and 5c depict tasks with disjoint input and output variable sets, whose variables are nonetheless measured in the same underlying space (dotted lines are samples) (FIGS. 5a and 5b) and architecture (FIG. 5c) wherein TOM can be applied to any task in this space to predict values at output locations, given values at input locations.

FIGS. 6a, 6b and 6c visualize how learned VEs capture underlying structure across tasks using TOM.

FIG. 7 is the code for the forward pass of the TOM model implemented in PyTorch.

### DETAILED DESCRIPTION OF THE EMBODIMENTS

In describing the preferred and alternate embodiments of the present disclosure, specific terminology is employed for the sake of clarity. The disclosure, however, is not intended to be limited to the specific terminology so selected, and it is to be understood that each specific element includes all technical equivalents that operate in a similar manner to accomplish similar functions. The disclosed embodiments are merely exemplary methods of the invention, which may be embodied in various forms.

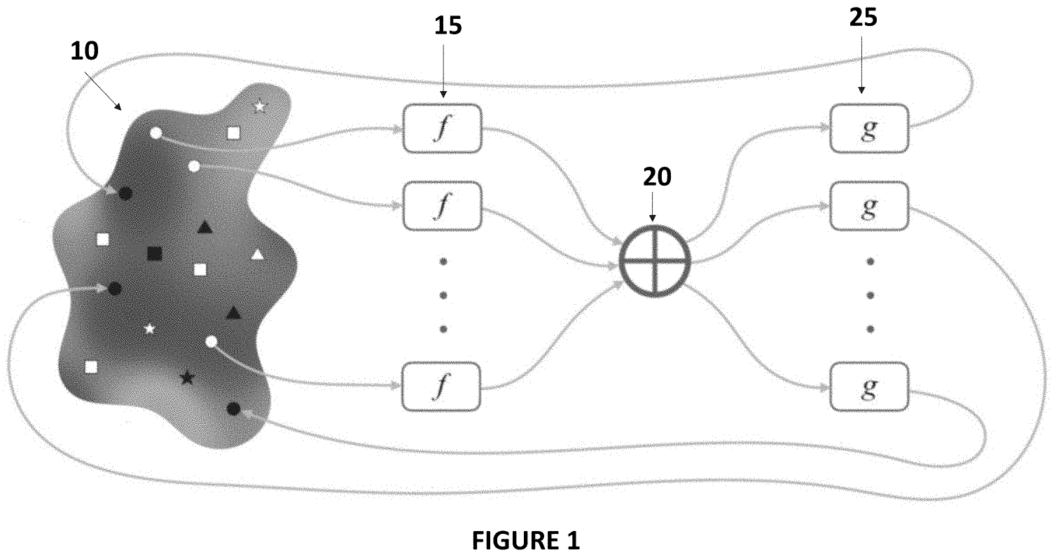

Generally, the embodiments herein propose multi-task learning through spatial variable embeddings, wherein all variable locations in a shared space are learned, while simultaneously training the prediction model itself, as shown in FIG. 1. FIG. 1 gives an example of four tasks whose variable values are measured at different locations in the same underlying 2D embedding space 10. The shape of each marker (i.e., ∘,□,Δ,★) denotes the task to which that variable belongs; white markers denote input variables, black markers denote output variables, and the background shading indicates the variable values in the entire embedding space when the current sample is drawn. As a concrete example, the shading could indicate the air temperature at each point in a geographical region at a given moment in time, and each marker could indicate the location of a temperature sensor (however, note that the embedding space is generally more abstract). FIG. 1 shows a model that can be applied to any task in this universe, using the ∘ task as an example, the function f encodes the value of each observed variable xᵢ given its 2D location zᵢ∈ [symbol] ² 15, and these encodings are aggregated by elementwise addition ⊕ 20. The function g decodes the aggregated encoding to a prediction for yⱼ at its location zⱼ 25. Such a predictor is reference herein as a traveling observer model (TOM). TOM traverses the space of variables, taking a measurement at the location of each input. Given these observations, the model can make a prediction for the value at the location of an output. In general, the embedded locations z are not known a priori (i.e., when input and output variables do not have obvious physical locations), but they can be learned alongside f and g by gradient descent.

The input and output spaces of a prediction problem can be standardized so that the measured value of each input and output variable is a scalar. The prediction model can then be completely agnostic about the particular task for which it is making a prediction. By learning variable embeddings (VEs), i.e., the z's, the model can capture variable relationships explicitly and supports joint training of a single architecture across seemingly unrelated tasks with disjoint input and output spaces. TOM thus establishes a new lower bound on the commonalities shared across real-world machine learning problems: They are all drawn from the same space of variables that humans can and do measure.

In accordance with one working embodiment, the input and output spaces of a prediction problem can be standardized so that the measured value of each input and output variable is a scalar. The prediction model can then be completely agnostic about the particular task for which it is making a prediction. By learning variable embeddings, the model can capture variable relationships explicitly and supports joint training of a single architecture across seemingly unrelated tasks with disjoint input and output spaces. TOM thus establishes a new lower bound on the commonalities shared across real-world machine learning problems: They are all drawn from the same space of variables that humans can and do measure.

In accordance with one general embodiment of present disclosure, the proposed solution develops a first implementation of TOM, using an encoder-decoder architecture, with variable embeddings incorporated using existing approaches. In one working embodiment, use of FiLM is proposed for incorporating variable embeddings. In the experiments, the implementation is shown to (1) recover the intuitive locations of variables in space and time, (2) exploit regularities across related datasets with disjoint input and output spaces, and (3) exploit regularities across seemingly unrelated tasks to outperform single-tasks models tuned to each tasks, as well as current Deep MTL alternatives. The results confirm that the proposed solution provides a promising framework for representing and exploiting the underlying processes of seemingly unrelated tasks.

As discussed further herein, TOM extends the notion of task embeddings to variable embeddings (VEs) in order to apply multi-task encoder decoder decomposition in the cross-domain setting. Accordingly, TOM embeds all input and output variables into a shared space as follows:

$$\frac{Variable Embeddings ( TOM )}{{\dot{y}}_{j} = g ( {\sum }_{{x}_{1} ∈ {x}_{1}} f ( {x}_{i} , {z}_{i} ) , {z}_{j} )}$$

Consider the set of all scalar random variables that could possibly be measured {v₁, v₂, . . . }=V. Each vᵢ∈V could be an input or output variable for some prediction task. To characterize each vᵢ semantically, associate with it a vector zᵢ∈ [symbol] ² that encodes the meaning of vᵢ, e.g., “height of left ear of human adult in inches,” “answer to survey question 9 on a scale of 1 to 5”, “severity of heart disease”, “brightness of top-left pixel of photograph”, etc. This vector zᵢ is called the variable embedding (VE) of vᵢ. Variable embeddings could be handcoded, e.g., based on some featurization of the space of variables, but such a handcoding is usually unavailable, and would likely miss some of the underlying semantic regularities across variables. An alternative approach is to learn variable embeddings based on their utility in solving prediction problems of interest.

A prediction task (x, y)=([x₁, . . . , xₙ], [y₁, . . . , yₘ]) is defined by its set of observed variables {xᵢ}ᵢ₌₁ⁿ⊆V and its set of target variables {yⱼ}ⱼ₌₁^{m}⊆V whose values are unknown. The goal is to find a prediction function Ω that can be applied across any prediction task of interest, so that it can learn to exploit regularities across such problems. Let zᵢ and zⱼ be the variable embeddings corresponding to xᵢ and yⱼ, respectively. Then, this universal prediction model is of the form

[symbol]

[yⱼ|x]=Ω(x,{zᵢ}ᵢ₌₁ⁿ,zⱼ). (1)

Importantly, for any two tasks (xₜ, yₜ), (x_{t′}, y_{t′}), their prediction functions (Eq. 1) differ only in their z's, which enforces the constraint that functionality is otherwise completely shared across the models. One can view Ω as a traveling observer, who visits several locations in the C-dimensional variable space, takes measurements at those locations, and uses this information to make predictions of values at other locations.

To make Ω concrete, it must be a function that can be applied to any number of variables, can fit any set of prediction problems, and is invariant to variable ordering, since we cannot in general assume that a meaningful order exists. These requirements lead to the following decomposition:

[symbol]

[yⱼ|x]=Ω(x,{zᵢ}ᵢ₌₁ⁿ,zⱼ)=g(Σᵢ₌₁ⁿf(xᵢ,zᵢ),zⱼ), (2)

where f and g are functions called the encoder and decoder, with trainable parameters θ_{f} and θ_{g}, respectively. The variable embeddings z tell f and g which variables they are observing, and these z can be learned by gradient descent alongside θ_{f} and θ_{g}. A depiction of the model is shown in FIG. 1. For some integer M, f: [symbol] ^{C+1}→ [symbol] ^{M} and g: [symbol] ^{M+C}→ [symbol] . In principle, f and g could be any sufficiently expressive functions of this form. A natural choice is to implement them as neural networks. They are called the encoder and decoder because they map variables to and from a latent space of size M. This model can then be trained end-to-end with gradient descent. A batch for gradient descent is constructed by sampling a prediction problem, e.g., a task, from the distribution of problems of interest, and then sampling a batch of data from the data set for that problem. Notice that, in addition to supervised training, in this framework it is natural to autoencode, i.e., predict input variables, and subsample inputs to simulate multiple tasks drawn from the same universe.

The question remains: How can f and g be designed so that they can sufficiently capture a broad range of prediction behavior, and be effectively conditioned by variable embeddings? The next section introduces an experimental architecture that satisfies these requirements.

The encoder and decoder are conditioned on VEs via FiLM layers, which provide a flexible yet inexpensive way to adapt functionality to each variable, and have been previously used to incorporate task embeddings. For simplicity, the FiLM layers are based on affine transformations of VEs. Specifically, the [symbol] th FiLM layer [symbol] is parameterized by affine layers [symbol] and [symbol] , and, given a variable embedding z, the hidden state h is modulated by

[symbol]

(h)= [symbol] (z)⊙h+ [symbol] (z), (3)

where ⊙ is the Hadamard product. A FiLM layer is located alongside each fully-connected layer in the encoder and decoder, both of which consist primarily of residual blocks. To avoid deleterious behavior of batch norm across diverse tasks and small datasets/batches, the recently proposed SkipInit described in De et al., Batch Normalization Biases Residual Blocks Towards the Identity Function in Deep Networks, arXiv:2002.10444v3, which is incorporated herein by reference in its entirety, is used as a replacement to stabilize training. SkipInit adds a trainable scalar α initialized to 0 at the end of each residual block, and uses dropout for regularization. Finally, for computational efficiency, the decoder is redecomposed into the Core, or g₁, which is independent of output variable, and the Decoder proper, or g₂, which is conditioned on the output variable. That way, generic transformations of the summed Encoder output can be learned by the Core and run in a single forward and backward pass each iteration. With this decomposition, Eq. 2 is rewritten as

[symbol]

[yⱼ|x]=g₂(g₁(Σᵢ₌₁ⁿf(xᵢ,zᵢ)),zⱼ). (4)

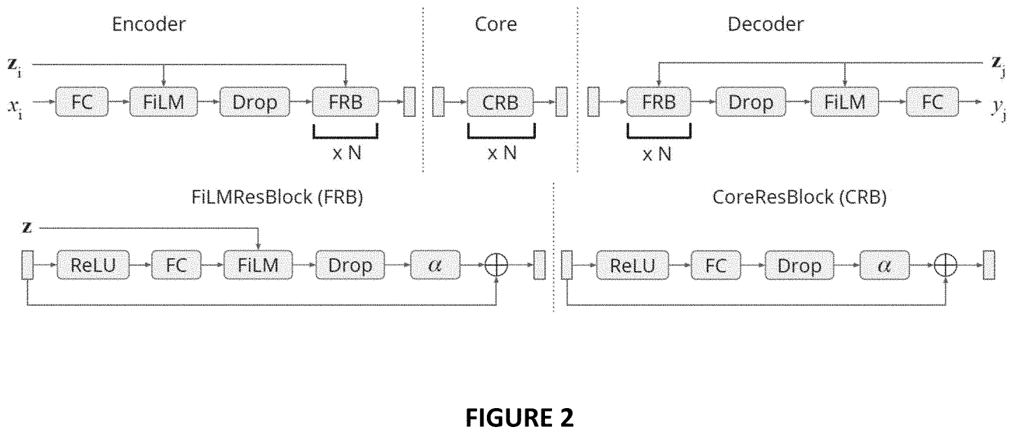

The complete architecture is depicted in FIG. 2. Encoder, Core, and Decoder correspond to f, g₁, and g₂ in Eq. 4, respectively. The Encoder and Decoder are conditioned on input and output VEs z via FiLM layers. A CoreResBlock (“CRB”) is simply a FiLMResBlock (“FRB”) without conditioning. Dropout and trainable scalars α implement SkipInit as a substitute for BatchNorm. This residual structure allows the architecture to learn tasks of varying complexity in a flexible manner.

In the following sections, all models are implemented in PyTorch, use Adam for optimization, and have hidden layer size of 128 for all layers. Variable embeddings for TOM are initialized from [symbol] (0,10⁻³).

In one working embodiment, we can test TOM's ability to learn variable embeddings that reflect our a priori intuition about the domain, in particular, the organization of space and time. In a first embodiment, the CIFAR dataset is utilized. The pixels of the 32×32 images are converted to grayscale values in [0, 1], yielding 1024 variables. The goal is to predict all variable values, given only a subset of them as input. The model is trained to minimize the binary cross-entropy of each output, and it uses 2D VEs. The a priori, i.e., Oracle, expectation is that the VEs form a 32×32 grid corresponding to how pixels are spatially laid out in an image.

In a second working embodiment, Melbourne minimum daily temperature dataset, a subset of a larger database for tracking climate change is utilized. As above, the goal is to predict the daily temperature of the previous 10 days, given only some subset of them, by minimizing the MSE of each variable. The a priori, Oracle, expectation is that the VEs are laid out linearly in a single temporal dimension. The goal is to see whether TOM will also learn VEs (in a 2D space) that follow a clear 1D manifold that can be interpreted as time.

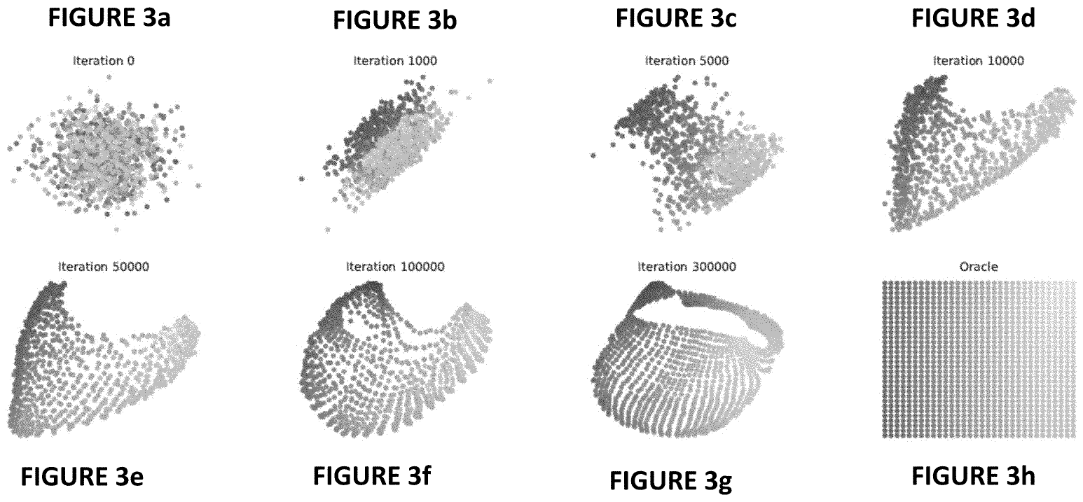

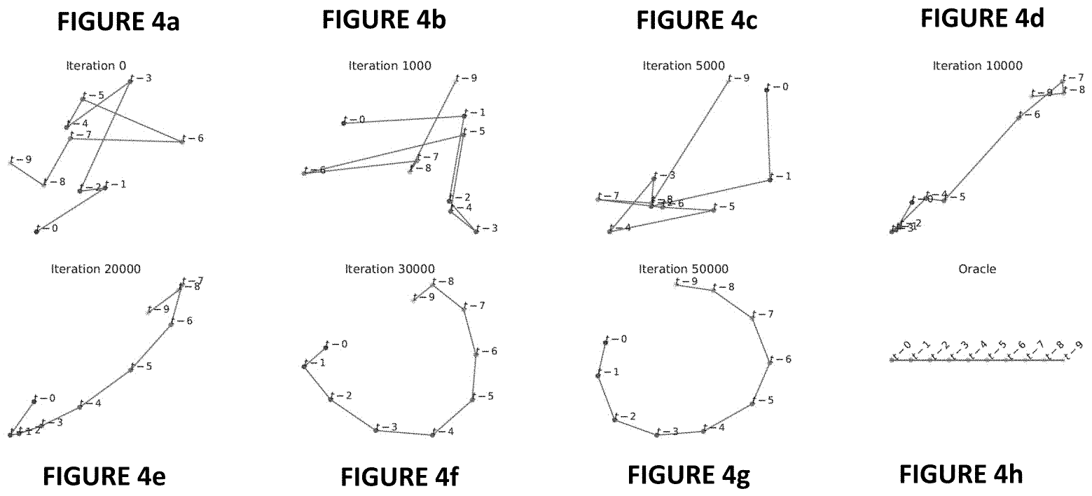

For both experiments, a subset of the input variables is randomly sampled at each training iteration, which simulates drawing tasks from a limited universe. The resulting learning process for the VEs is illustrated in FIGS. 3a-3h and 4a-4h. The VEs for CIFAR pull apart and unfold, until they reflect the oracle embeddings (FIG. 3a-3h). The remaining difference is that TOM peels the border of the CIFAR images (the upper loop of VEs at iteration 300K) away from their center (the lower grid). This makes sense, since CIFAR images all feature a central object, which semantically splits the image into foreground (the object itself) and background (the remaining ring of pixels around the object). Similarly, the VEs for daily temperature pull apart until they form a perfect 1D manifold representing the time dimension (FIG. 4a-4h). The main difference is that TOM has embedded this 1D structure as a ring in 2D, which is well-suited to the nonlinear encoder and decoder since it mirrors an isotropic Gaussian distribution. Note that unlike visualization methods like SOM, or t-SNE, TOM learns locations for each variable not each sample. Furthermore, TOM has no explicit motivation to visualize; learned VEs are simply the locations found to be useful by using gradient descent when solving the prediction problem.

To get an idea of how learning VEs affects prediction performance, comparisons were run with three cases of fixed VEs: (1) all VEs set to zero, to address the question of whether differentiating variables with VEs is needed at all in the model; (2) random VEs, to address the question of whether simply having any unique label for variables is sufficient; and (3) oracle VEs, which reflect the human a priori expectation of how the variables should be arranged. The results show that the learned embeddings outperform zero and random embeddings, achieving performance on par with the Oracle (Table 2). This table compares test errors (±std. err.) of learned VEs to fixed-VE alternatives in TOM. The results show that learned VEs outperform Zero and Random VEs, reaching performance on par with the Oracle. That is, TOM not only learns meaningful VEs (FIGS. 3a-3h and 4a-4h), but also uses these VEs to achieve superior performance. The conclusion is that learned VEs in TOM are not only meaningful, but can help make superior predictions, without a priori knowledge of variable meaning.

TABLE 2

| Variable Embeddings | Zero | Random | Learned | Oracle |
|---|---|---|---|---|
| CIFAR | 0.662 ± 0.0000 | 0.660 ± 0.0007 | 0.591 ± 0.0002 | 0.590 ± 0.0001 |
| (Binary Cross-entropy) | | | | |
| Daily Temperature (RMSE) | 4.29 ± 0.002 | 4.27 ± 0.011 | 3.32 ± 0.011 | 3.37 ± 0.005 |

The next embodiment shows how such VEs can be used to exploit regularities across tasks in an MTL setting. In accordance with one example embodiment, two synthetic multi-task problems that contain underlying regularities across tasks are considered. These regularities are not known to the model a priori; it can only exploit them via its VEs.

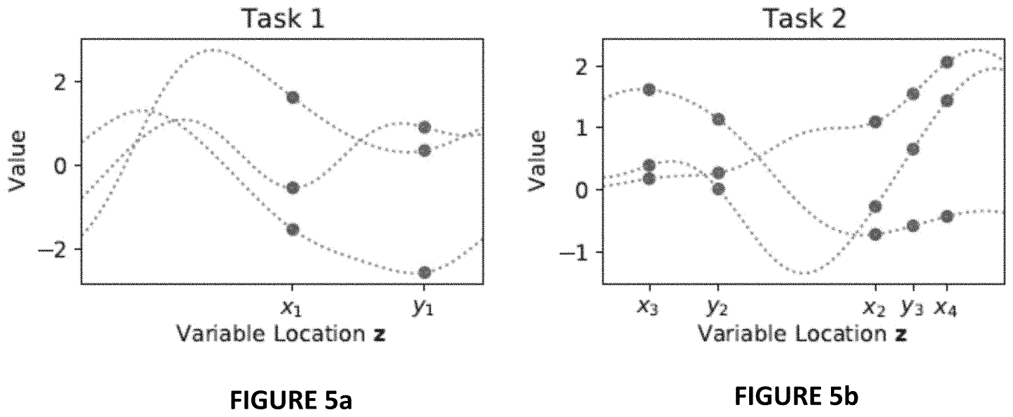

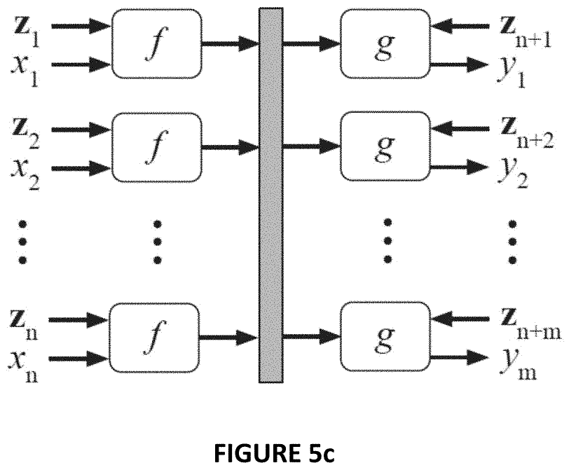

The first problem, a transposed gaussian process problem, evaluates TOM in a regression setting where input and output variables are drawn from the same continuous space; the second problem evaluates TOM in a classification setting. In the first problem, the universe is defined by a Gaussian process (GP). The GP is 1D, is zero-mean, and has an RBF kernel with length-scale 1. One task is generated for each (#inputs, #outputs) pair in {1, . . . , 10}×{1, . . . , 10}, for a total of 100 tasks. The “true” location of each variable lies in the single dimension of the GP, and is sampled uniformly from [0, 5]. Samples for the task are generated by sampling from the GP, and measuring the value at each variable location. Each task contains 10 training samples, 10 validation samples, and 100 test samples. Samples are generated independently for each task. The goal is to minimize MSE of the outputs. FIGS. 5a, 5b and 5c give two examples of tasks drawn from this universe. This testbed is ideal for TOM, because, by the definition of the GP, it explicitly captures the idea that variables whose VEs are nearby are closely related, and every variable has some effect on all others. FIGS. 5a and 5b illustrates tasks with disjoint input and output variable sets, whose variables are nonetheless measured in the same underlying space (dotted lines are samples). These tasks are drawn from the transposed gaussian process problem. In FIG. 5c, TOM can be applied to any task in this space: It predicts values at output locations, given values at input locations.

In the second problem, each task is defined by a set of concentric hyperspheres. Many areas of human knowledge have been organized abstractly as such hyperspheres, e.g., planets around a star, electrons around an atom, social relationships around an individual, or suburbs around Washington D.C.; the idea is that a model that discovers this common organization could then share general knowledge across such areas more effectively. To test this hypothesis, one task is generated for each (#features n, #classes m) pair in {1, . . . ,10}×{2, . . . ,10}, for a total of 90 tasks. For each task, its origin oₜ is drawn from [symbol] (0, Iₙ). Then, for each class c∈{1, . . . , m}, samples are drawn from [symbol] ⁿ uniformly at distance c from oₜ, i.e., each class is defined by a (hyper) annulus. The dataset for each task contains five training samples, five validation samples, and 100 test samples per class. The model has no a priori knowledge that the classes are structured in annuli, or which annulus corresponds to which class, but it is possible to achieve high accuracy by making analogies of annuli across tasks, i.e., discovering the underlying structure of this universe.

In these experiments, TOM is compared to five alternative methods: (1) TOM-STL, i.e. TOM trained on each task independently; (2) DR-MTL (Deep Residual MTL), the standard cross-domain (Table 1, c) version of TOM, where instead of FiLM layers, each task has its own linear encoder and decoder layers, and all residual blocks are CoreResBlocks; (3) DR-STL, which is like DR-MTL except it is trained on each task independently; (4) SLO, which uses a separate encoder and decoder for each task, and which is (as far as we know) the only prior Deep MTL approach that has been applied across disjoint tabular datasets; and (5) Oracle, i.e. TOM with VEs fixed to intuitively correct values. The Oracle is included to give an upper bound on how well the TOM architecture of FIG. 2 could possibly perform. The oracle VE for each Transposed GP task variable is the location where it is measured in the GP; for Concentric Hyperspheres, the oracle VE for each class c is c10, and for the ith feature is oᵢ^{t}.

TOM outperforms the competing methods and achieves performance on par with the Oracle (Table 3, shown below). Note that the improvement of TOM over TOM-STL is much greater than that of DR-MTL over DR-STL, indicating that TOM is particularly well-suited to exploiting structure across disjoint data sets.

TABLE 3

| | Transposed | Concentric |
|---|---|---|
| Method | GP (MSE) | Hyperspheres (Accuracy) |
| DR-STL | 0.373 ± 0.030 | 42.56 ± 1.69 |
| TOM-STL | 0.552 ± 0.027 | 64.52 ± 1.83 |
| DR-MTL | 0.397 ± 0.032 | 54.42 ± 1.92 |
| SLO | 0.568 ± 0.028 | 53.26 ± 1.91 |
| TOM | 0.346 ± 0.031 | 92.90 ± 1.49 |
| Oracle | 0.342 ± 0.026 | 99.96 ± 0.02 |

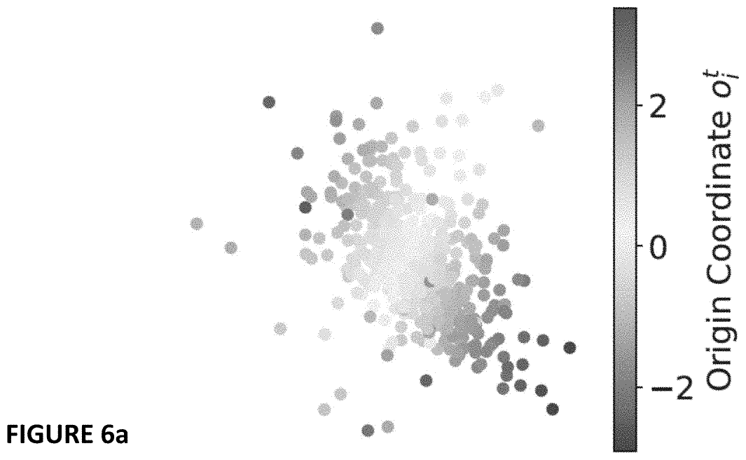

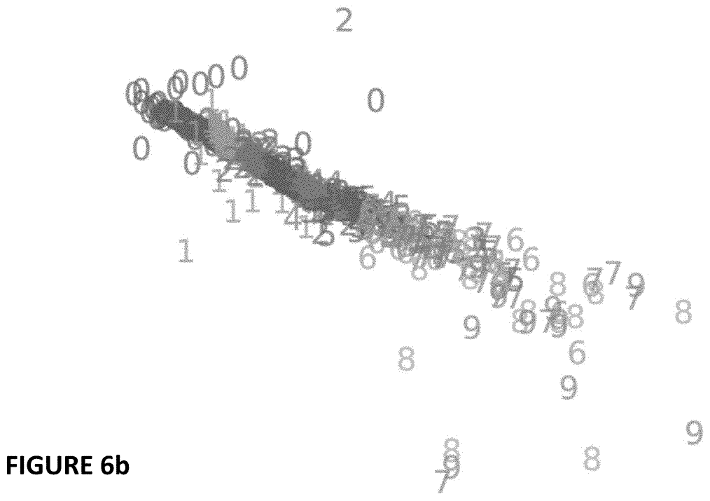

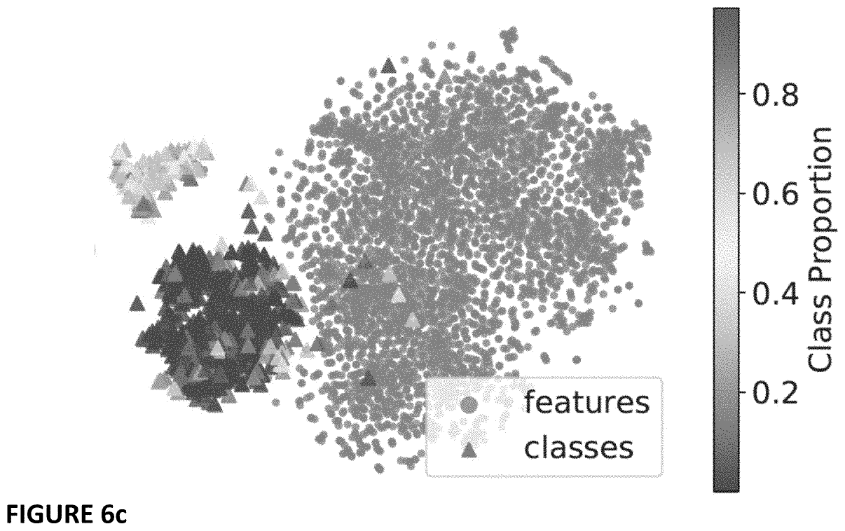

Learned VEs are shown in FIGS. 6a, 6b and 6c, wherein VEs of features for concentric hyperspheres encode the origin location are shown in FIG. 6a and VEs of features for classes encode the index of their annuli (less precisely for the more distant annuli, since they occur in fewer tasks) as shown in FIG. 6b. FIG. 6c (referenced further below), shows VEs for UCI-121 (shown in 2D via t-SNE) neatly carve the space into features, common classes, and uncommon classes.

Now that this suitability has been confirmed, the next embodiment evaluates TOM across a suite of disjoint, and seemingly unrelated, real-world problems. TOM is evaluated in the setting for which it was designed: learning a single shared model across seemingly unrelated real-world datasets. In one example embodiment, the set of tasks used is UCI-121, a set of 121 classification tasks, the tasks that come from diverse areas such as medicine, geology, engineering, botany, sociology, politics, and game-playing. Prior work has tuned each model to each task individually in the single-task regime; no prior work has undertaken learning of all 121 tasks in a single joint model. The datasets are highly diverse. Each simply defines a classification task that a machine learning practitioner was interested in solving. The number of features for a task range from 3 to 262, the number of classes from 2 to 100, and the number of samples from 10 to 130,064. To avoid underfitting to the larger tasks, C=128, and after joint training all model parameters (θ_{f}, θ_{g}_{₁}, θ_{g}_{₂}, and z's) are finetuned on each task with at least 5K samples. Note that it is not expected that training any two tasks jointly will improve performance in both tasks, but that training all 121 tasks jointly will improve performance overall, as the model learns general knowledge about how to make good predictions.

Results across a suite of metrics are shown in Tables 4a and 4b. Mean Accuracy is the test accuracy averaged across all tasks. Normalized Accuracy scales the accuracy within each task before averaging across tasks, with 0 and 100 corresponding to the lowest and highest accuracies. Mean Rank averages the method's rank across tasks, where the best method gets a rank of 0. Best % is the percentage of tasks for which the method achieves the top accuracy (with possible ties). Win % is the percentage of tasks for which the method achieves accuracy strictly greater than all other methods. Table 4a shows comparisons to external results of deep STL models tuned to each task. Table 4b shows comparisons across methods evaluated herein. Metrics are aggregated over all 121 tasks (±std. err.) TOM outperforms the alternative approaches across all metrics, showing its ability to learn many seemingly unrelated tasks successfully in a single model (see FIG. 6c for a high-level visualization of learned VEs). In other words, TOM can both learn meaningful VEs and use them to improve prediction performance.

TABLE 4a

| Method | Win % | Best % | Mean Rank | Norm. Acc. | Mean Acc. |
|---|---|---|---|---|---|
| ResNet | 3.31 ± 1.63 | 12.40 ± 3.03 | 3.89 ± 0.19 | 50.07 ± 3.15 | 79.24 ± 1.59 |
| MS | 4.96 ± 1.98 | 14.88 ± 3.28 | 3.35 ± 0.19 | 60.11 ± 3.00 | 80.11 ± 1.48 |
| BN | 5.79 ± 2.13 | 13.22 ± 3.11 | 4.20 ± 0.20 | 42.15 ± 3.24 | 77.01 ± 1.83 |
| WN | 7.44 ± 2.40 | 10.74 ± 2.84 | 4.05 ± 0.20 | 45.87 ± 3.11 | 77.43 ± 1.74 |
| HW | 8.26 ± 2.51 | 15.70 ± 3.35 | 3.61 ± 0.21 | 53.00 ± 3.20 | 78.68 ± 1.61 |
| LN | 9.92 ± 2.73 | 16.53 ± 3.40 | 3.45 ± 0.20 | 56.73 ± 3.03 | 79.85 ± 1.53 |
| SNN | 13.22 ± 3.09 | 21.49 ± 3.78 | 2.78 ± 0.19 | 65.29 ± 2.84 | 81.39 ± 1.35 |
| TOM | 28.93 ± 4.14 | 34.71 ± 4.36 | 2.60 ± 0.22 | 70.72 ± 3.02 | 81.53 ± 1.44 |

TABLE 4b

| Method | Win % | Best % | Mean Rank | Norm. Acc. | Mean Acc. |
|---|---|---|---|---|---|
| DR-STL | 10.74 ± 2.82 | 19.01 ± 3.60 | 2.31 ± 0.12 | 54.72 ± 3.51 | 76.48 ± 1.68 |
| TOM-STL | 7.44 ± 2.40 | 16.53 ± 3.40 | 2.72 ± 0.13 | 35.21 ± 3.72 | 68.18 ± 2.26 |
| DR-MTL | 9.09 ± 2.62 | 28.10 ± 4.12 | 2.02 ± 0.12 | 56.47 ± 3.68 | 78.40 ± 1.47 |
| SLO | 16.53 ± 3.39 | 30.06 ± 4.22 | 1.62 ± 0.10 | 73.88 ± 2.93 | 80.31 ± 1.38 |
| TOM | 32.23 ± 4.27 | 47.10 ± 4.58 | 1.34 ± 0.13 | 76.70 ± 3.08 | 81.53 ± 1.44 |

For the experiments underlying the comparisons in Tables 4a and 4b, C was selected to be equal to 128 order to match the number of task-specific parameters of the other Deep MTL methods. Table 5 shows the results of additional experiments that were run on UCI-121 with C=64 and C=256 to evaluate the sensitivity of TOM to the setting of C. Metrics for all settings of C are computed with respect to the external comparison methods, i.e., those in Table 4a. TOM with C=64 produces performance comparable to C=128, suggesting that optimizing C could be a useful lever for balancing performance and VE interpretability.

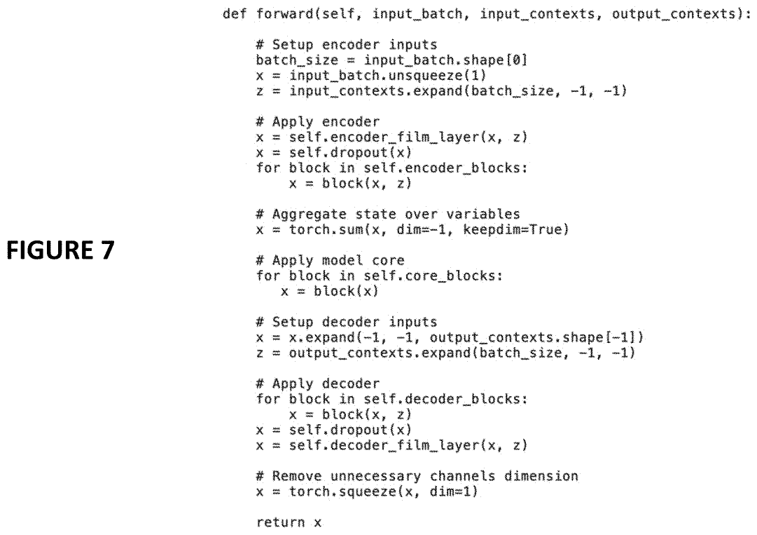

FIG. 7 is the code for the forward pass of the model implemented in PyTorch, providing an exemplary picture of how the TOM architecture is implemented in the embodiments discussed herein. One skilled in the art recognizes PyTorch as an open source machine learning library and implementation in PyTorch is exemplary. For efficiency, TOM is implemented with Conv1D layers with kernel size 1 instead of Dense layers. This approach enables the model to run the encoder and decoder on all variables in parallel. The fact that Conv layers are so highly optimized in PyTorch makes the implementation substantially more efficient than with Dense layers. In this code, input_batch has shape (batch size, input variables), input_contexts has shape (1, VE dim, #input variables), and output_contexts has shape (1, VE dim, #output variables). Additional code for TOM is provided in the Appendix filed herewith.

Additional embodiment details are provided herein below. One skilled in the art will appreciate that variations to the proof-of-concept experimental configurations can be made without departing from the scope of the embodiments.

For the CIFAR experiments, a sigmoid layer is applied at the end of the decoder to squash the output between 0 and 1.

For the CIFAR and Daily Temperature experiments, a subset of the variables is sampled each iteration to be used as input. This subset is sampled in the following way: (1) Sample the size k of the subset uniformly from [1, nₜ], where nₜ is the number of variables in the experiment; (2) Sample a subset of variables of size k uniformly from all subsets of size k. This sampling method ensures that every subset size has an equal chance of getting selected, so that the universe is not biased towards tasks of a particular size. E.g., if instead the subset were created by sampling each variable independently with probability p, then the subset size would concentrate tightly around pnₜ.

For classification tasks, each class defines a distinct output variable, i.e., a K-class classification task has K output variables. The squared hinge loss was used for classification tasks. Square hinge loss is preferable to categorical cross-entropy loss in this setting because it does not require taking a softmax across output variables, so the outputs are kept separate. Also, the loss becomes exactly zero once a sample is learned strongly, so that the model does not continue to overfit as remaining samples and tasks are learned.

The number of blocks in the encoder, core, and decoder is N=3 for all problems except UCI-121, for which it is N=10. All experiments use a hidden size of 128 for all dense layers aside from the final decoder layer that maps to the output space.

The batch size was 32 for CIFAR and Daily Temperature, and max(200, #trainsamples) for all other tasks. At each step, Tₒ tasks are uniformly sampled from the set of all tasks, and gradients are summed over a batch for each task in the sample. Tₒ=1 in all experiments except UCI-121, for which Tₒ=32.

To allow for multi-task training with datasets of varying numbers of samples, we say the model has completed one epoch each time it is evaluated on the validation set. An epoch is 1000 steps for CIFAR, 100 steps for Daily Temperature, 1000 steps for Transposed Gaussian Process, 1000 steps for Concentric Hyperspheres, and 10,000 steps for UCI-121.

For CIFAR, the official training and test splits are used for training and testing. No validation set is needed for CIFAR, because none of the models can overfit to the training set. For Daily Temperature, the second-to-last year of data is withheld for validation, and the final year is withheld for testing. The UCI-121 experiments use the preprocessed versions of the official train-val-test splits which are publicly available and known to those skilled in the art.

Adam is used for all experiments, with all parameters initialized to their default values. In all experiments except UCI-121, the learning rate is kept constant at 0.001 throughout training. In UCI-121, the learning rate is decreased by a factor of two when the mean validation accuracy has not increased in 20 epochs; it is decreased five times; model training stops when it would be decreased a sixth time. Models are trained for 500K steps for CIFAR, 100K steps for Daily Temperature, and 250K for Transposed Gaussian Process and Concentric Hyperspheres. The test performance for each task is its performance on the test set after the epoch of its best validation performance.

Weights are initialized using the default PyTorch initialization (aside from the SkipInit α scalars, which are initialized to zero). The CIFAR and daily temperature experiments use no weight decay; the transposed gaussian process and concentric hyperspheres experiments use weight decay of 10⁻⁴; and the UCI-121 experiments use weight decay of 10⁻⁵. Dropout is set to 0.0 for CIFAR, Daily Temperature, and Concentric Hyperspheres; and 0.5 for Transposed Gaussian Process and UCI-121.

In UCI-121, fully-trained MTL models are finetuned to tasks with more than 5,000 samples, using the same optimizer configuration as for joint training, except the steps-per-epoch is set to ┌#trainsamplesbatchsize┐, the learning rate is initialized to 0.0001, the patience for early stopping is set to 100, and the validation performance is smoothed over every 10 epochs (simple moving average), following the protocol used to train single-task models in prior work by Klambauer et al., Self-normalizing neural networks, In Proc. of NeurIPS, pp. 971-980 (2017), which is incorporated herein by reference in its entirety.

TOM uses a VE size of C=2 for all experiments, except for UCI-121, where C=128 in order to accommodate the complexity of such a large and diverse set of tasks. For FIG. 6c, t-SNE] was used to reduce the dimensionality to two. t-SNE was run for 10K iterations with default parameters in the scikit-learn implementation, after first reducing the dimensionality from 128 to 32 via PCA. Independent runs of t-SNE yielded qualitatively similar results.

Autoencoding (i.e., predicting the input variables as well as unseen variables) was used for CIFAR, Daily Temperature, and Transposed Guassian Process; it was not used for Concentric Hyperspheres or UCI-121.

The Soft Layer Ordering (SLO) architecture follows the original implementation described in co-owned U.S. patent application Ser. No. 16/172,660 entitled BEYOND SHARED HIERARCHIES: DEEP MULTITASK LEARNING THROUGH SOFT LAYER ORDERING, which is incorporated herein by reference in its entirety. There are four shared ReLU layers, each of size 128, with dropout after each to ease sharing across different soft combinations of layers.

As discussed herein with respect to various exemplary embodiments, TOM enables a single model to be trained across diverse tasks by embedding all task variables into a shared space. The framework is shown to discover intuitive notions of space and time and use them to learn variable embeddings that exploit knowledge across tasks, outperforming single- and multi-task alternatives. Thus, learning a single function that cares only about variable locations and their values is a promising approach to integrating knowledge across data sets that have no a priori connection. The TOM approach thus extends the benefits of multi-task learning to broader sets of tasks.

It is submitted that one skilled in the art would understand the various computing or processing environments, including computer readable mediums, which may be used to implement the processes described herein. Selection of computing environment and individual components may be determined in accordance with memory requirements, processing requirements, security requirements and the like. It is submitted that one or more steps or combinations of steps of the methods described herein may be developed locally or remotely, i.e., on a remote physical computer or virtual machine (VM). Virtual machines may be hosted on cloud-based IaaS platforms such as Amazon Web Services (AWS) and Google Cloud Platform (GCP), which are configurable in accordance memory, processing, and data storage requirements. One skilled in the art further recognizes that physical and/or virtual machines may be servers, either stand-alone or distributed. Distributed environments many include coordination software such as Spark, Hadoop, and the like. For additional description of exemplary programming languages, development software and platforms and computing environments which may be considered to implement one or more of the features, components and methods described herein, the following articles are referenced and incorporated herein by reference in their entirety: Python vs R for Artificial Intelligence, Machine Learning, and Data Science; Production vs Development Artificial Intelligence and Machine Learning; Advanced Analytics Packages, Frameworks, and Platforms by Scenario or Task by Alex Cistrons of InnoArchiTech, published online by O'Reilly Media, Copyright InnoArchiTech LLC 2020.

The foregoing description is a specific embodiment of the present disclosure. It should be appreciated that this embodiment is described for purpose of illustration only, and that those skilled in the art may practice numerous alterations and modifications without departing from the spirit and scope of the invention. It is intended that all such modifications and alterations be included insofar as they come within the scope of the invention as claimed or the equivalents thereof.

```
      “‘’”
      Class for skipinit residual blocks without FiLM, implemented using
      Conv1D in order to maintain TOM implementation pattern.
      “‘’”
      import torch
      import torch.nn as nn
      class CoreResBlock(nn.Module):
          def_init_(self,
                hidden_size,
                dropout=0.0):
              super(CoreResBlock, self)._init_()
              self.conv_layer = nn.Conv1d(hidden_size,
                        hidden_size,
                        1)
              self.dropout_layer = nn.Dropout(dropout)
              self.alpha = nn.Parameter(torch.zeros(1))
          def forward(self, x):
              identity = x
              x = torch.relu(x)
              x = self.conv_layer(x)
              x = self.dropout_layer(x)
              x = self.alpha * x
    return identity + x
“‘’”
Class for FiLM layer to support modulation by variable embeddings (VEs),
implemented using Conv1D for efficient parallel processing.
“‘’”
import torch.nn as nn
class VEFilmLayer(nn.Module):
  def_init_(self,
            input_size,
            output_size,
            context_size):
    super(VEFilmLayer, self)._init_( )
    self.scale_layer = nn.Conv1d(context_size,
                  outputsize,
                  1)
    self.shift_layer = nn.Conv1d(context_size,
                  output_size,
                  1)
    self.value_layer = nn.Conv1d(input_size,
                  output_size,
                  1)
  def forward(self, x, z):
    return self.scale_layer(z) * \
        self.value_layer(x) + \
        self. shift_layer(z)
“‘’”
Class for skipinit residual blocks using FiLM
“‘’”
import torch
import torch.nn as nn
from film_layer import VEFilmLayer
class FilmResBlock(nn.Module):
  def_init_(self,
            context_size,
            hidden_size,
            dropout=0.0):
    super(FilmResBlock, self)._init_( )
    self.film_layer = VEFilmLayer(hidden_size,
                  hidden_size,
                  contextsize)
    self.dropout_layer = nn.Dropout(dropout)
    self.alpha = nn.Parameter(torch.zeros(1))
  def forward(self, x, z):
    identity = x
    x = torch.relu(x)
    x = self.film_layer(x, z)
    x = self.dropout_layer(x)
    x = self.alpha * x
    return identity + x
“‘’”
Class for Inverted VE FiLM layer (used in decoder),
implemented using Conv1D for efficient parallel processing.
“‘’”
import torch.nn as nn
class InvVEFilmLayer(nn.Module):
  def_init_(self,
            input_size,
            output_size,
            context_size):
    super(InvVEFilmLayer, self)._init_( )
    self.scale_layer = nn.Conv1d(context_size,
                  input_size,
                  1)
    self.shift_layer = nn.Conv1d(context_size,
                  input_size,
                  1)
    self.value_layer = nn.Conv1d(input_size,
                  output_size,
                  1)
  def forward(self, x, z):
    return self.value_layer(
              self.scale_layer(z) * x + \
              self. shift_layer(z))
“‘’”
Class for TOM implemented as in paragraphs [0040] to [0042] herein.
“‘’”
import torch
import torch.nn as nn
from core res block import CoreResBlock
from film_layer import VEFilmLayer
from film_res_block import FilmResBlock
from inv_film_layer import InvVEFilmLayer
class TOM(nn.Module):
  def_init_(self,
            ve_size,
            hidden_size,
            num_encoder_layers,
            num_core_layers,
            num_decoder_layers,
            dropout=0.0):
    super(TOM, self)._init_( )
    # Create Encoder
    self.encoder_film_layer = VEFilmLayer(1,
                      hidden_size,
                      ve_size)
    self.encoder_blocks = nn.ModuleList([ ])
    for i in range(num_encoder_layers − 1):
      encoder_block = FilmResBlock(ve size,
                    hidden_size,
                    dropout)
      self.encoderblocks.append(encoder_block)
    # Create Core
    self.core_blocks = nn.ModuleList([ ])
    for i in range(num_core_layers):
      core_block = CoreResBlock(hidden_size,
                  dropout)
      self.core_blocks.append(core_block)
    # Create Decoder
    self.decoder_blocks = nn.ModuleList([ ])
    for i in range(num_decoder_layers − 1):
      decoder_block = FilmResBlock(ve_size,
                    hidden_size,
                    dropout)
      self.decoder_blocks.append(decoder_block)
    self.decoder_film_layer = InvVEFilmLayer(hidden_size,
                        1,
                        ve_size)
    # Create dropout layer
    self.dropout = nn.Dropout(dropout)
  def forward(self, input_batch, input_ves, output_ves)
    # Setup encoder inputs
    batch_size = input_batch.shape[0]
    x = input_batch.unsqueeze(1)
    z = input_ves.expand(batch_size, −1, −1)
    # Apply encoder
    x = self.encoder_film_layer(x, z)
    x = self.dropout(x)
    for block in self.encoder_blocks:
      x = block(x, z)
    # Aggregate state over variables
    x = torch.sum(x, dim=−1, keepdim=True)
    # Apply model core
    for block in self.core_blocks:
      x = block(x)
    # Setup decoder inputs
    x = x.expand(−1, −1, output_ves.shape[−1])
    z = output_ves.expand(batch_size, −1, −1)
    # Apply decoder
    for block in self.decoder_blocks:
      x = block(x, z)
    x = self.dropout(x)
    x = self.decoder_film_layer(x, z)
    # Remove unnecessary channels dimension
    x = torch.squeeze(x, dim=1)
    return x
if name ==‘_main_’:
  model = TOM(2, 128, 3, 3, 3, 0.2)
  print(model)
```

1. A process, implemented in a computing environment, for training a single model across diverse tasks, comprising:
measuring tasks with disjoint input and output variable sets in a shared space;
for each task,
encoding by a function f a value of each observed variable xᵢ given its shared space location zᵢ;
aggregating encodings by elementwise addition; and
decoding by a function g the aggregated encodings to predict yⱼ at its location zⱼ, wherein zᵢ and zⱼ are variable embeddings.

2. The process according to claim 1, wherein the encoding and decoding are conditioned on the variable embeddings via Feature-wise Linear Modulation (FiLM) layers.

3. The process according to claim 1, wherein function g is re-decomposed into a core, which is independent of output variable, and a decoder, g₂, which is conditioned on output variable.

4. The process according to claim 3, wherein the single model is in the form of: [symbol]
[yⱼ|x]=g₂(g₁(Σᵢ₌₁ⁿf(xᵢ,zᵢ)),zⱼ).

5. The process according to claim 1, wherein functions f and g are implemented as neural networks.

6. The process according to claim 5, wherein the neural networks are residual block networks. The process according to claim 1, wherein the shared space is 2-Dimensional.

8. At least one computer-readable medium storing instructions that, when executed by a computer, perform a process for training a single model across diverse tasks, the process comprising:
measuring tasks with disjoint input and output variable sets in a shared space;
for each task,
encoding by a function f a value of each observed variable xᵢ given its shared space location zᵢ;
aggregating encodings by elementwise addition; and
decoding by a function g the aggregated encodings to predict yⱼ at its location zⱼ, wherein zᵢ and zⱼ are variable embeddings.

9. The at least one computer-readable medium of claim 8, wherein the encoding and decoding are conditioned on the variable embeddings via Feature-wise Linear Modulation (FiLM) layers.

10. The at least one computer-readable medium of claim 8, wherein function g is re-decomposed into a core, g₁, which is independent of output variable, and a decoder, g₂, which is conditioned on output variable.

11. The at least one computer-readable medium of claim 10, wherein the single model is in the form of: [symbol]
[yⱼ|x]=g₂(g₁(Σᵢ₌₁ⁿf(xᵢ,zᵢ)),zⱼ).

12. The at least one computer-readable medium of claim 8, wherein functions f and g are implemented as neural networks.

13. The at least one computer-readable medium of claim 12, wherein the neural networks are residual block networks.

14. The computer-readable medium of claim 8, wherein the shared space is 2-Dimensional.

15. A single universal prediction model trained across diverse tasks in a shared space with disjoint input and output variable sets, the single universal prediction model comprising:
an encoder, f, which is conditioned on vector zᵢ, for generating an encoder output for each task variable xᵢ given its location in the shared space;
an aggregator for aggregating the encoder outputs;
a core, g₁, which is independent of output variable; and
a decoder, g₂, which is conditioned on vector zⱼ, for generating a prediction yⱼ given its location in the shared space.

16. The single universal prediction model of claim 15, having the form of: [symbol] [yⱼ|x]=g₂(g₁(Σᵢ₌₁ⁿ f(xᵢ,zᵢ)), zⱼ).

17. The single universal prediction model of claim 15, wherein vector zᵢ and zⱼ are variable embeddings.

18. The single universal prediction model of claim 15, wherein functions f and g are implemented as neural networks.

19. The single universal prediction model of claim 18, wherein the neural networks are residual block networks.

20. The single universal prediction model of claim 15, wherein the encoder and decoder are conditioned on the variable embeddings via Feature-wise Linear Modulation (FiLM) layers.
